(19) United States
(12) Patent Application Publication
(10) Pub. No.: US 2026/0310522 A1
(43) Pub. Date: Oct. 8, 2026

(54) CONTROLLED DATA DISTRIBUTION IN CONTAINER ORCHESTRATION

(71) Applicant: International Business Machines Corporation, Armonk, NY (US)

(72) Inventors: Paritosh RANJAN, Kolkata (IN); Prodip ROY, Kolkata (IN); Bhubaneswar PADHAN, KOLKATA (IN); SWARUP KUMAR SIKDER, Kolkata (IN)

(21) Appl. No.: 19/097,921

(22) Filed: Apr. 2, 2025

(51) Int. Cl. G06F 9/50

(52) U.S. Cl. CPC G06F 9/5083

(57) ABSTRACT

Controlled distribution of workloads among container groups in orchestration services is performed according to an orchestration service description configuration file, which supports validating, formatting, selecting container sets, and distributing formatted input data for processing. Individual container feedback drives ongoing workload distribution to completion. Container feedback includes status reports and data processing statistics. Ongoing workload distribution includes reading portions of data from a target dataset, validating and formatting the portions of data until no more data is available to be read from the target dataset.

### BACKGROUND

The present invention relates generally to the field of container orchestration systems, and more particularly to controlled data distribution.

Container orchestration systems manage containerized applications across a cluster of virtual machines, simplifying the process of deploying and scaling applications. Examples of such orchestration systems include Kubernetes, Docker, and Apache. Note: the terms “KUBERNETES,” “DOCKER,” and/or “APACHE” may be subject to trademark rights in various jurisdictions throughout the world and are used here only in reference to the products or services properly denominated by the marks to the extent that such trademark rights may exist.

### SUMMARY

In one aspect of the present invention, a method, a computer program product, and a system for controlled parallel distribution of a data workload via container orchestration includes: reading input data from a dataset in storage, the input data being a portion of the dataset, the portion determined according to pre-defined capacities of a set of containers including individual containers, the set of containers being assigned to process the dataset; distributing, in parallel, batches of the input data to the set of containers, the batches assigned to the individual containers according to configured distribution rules; retrieving data processing status reports from the individual containers while processing their respectively assigned batches; and distributing additional input data to the individual containers based on the retrieved data processing status reports.

Another aspect of the present invention includes reading an orchestration service description configuration file for container orchestration, the orchestration service description configuration file including the configured distribution rules and the pre-defined capacities of the individual containers.

Yet another aspect of the present invention includes: analyzing the processing status reports to determine current capacities of the individual containers; retrieving the additional input data from the dataset in the storage based on the current capacities; formatting the additional input data for distribution; and distributing the formatted additional input data to the individual containers according to the current capacities.

### BRIEF DESCRIPTION OF THE SEVERAL VIEWS OF THE DRAWINGS

FIG. 1 is a schematic view of a first embodiment of a system according to the present invention;

FIG. 2 is a schematic view of a first embodiment of a machine logic (for example, software) portion of the first embodiment system;

FIG. 3 is a schematic view of a first embodiment of distribution service communications paths in an orchestration system according to the present invention;

FIG. 4 is a flowchart showing a method performed, at least in part, by the first embodiment system;

FIG. 5 is a schematic view of a second embodiment of distribution service communications paths in an orchestration system according to the present invention; and

FIG. 6 is a schematic view of a third embodiment of distribution service communications paths in an orchestration system according to the present invention.

### DETAILED DESCRIPTION

Controlled distribution of workloads among container groups in orchestration services is performed according to an orchestration service description configuration file, which supports validating, formatting, selecting container sets, and distributing formatted input data for processing. Individual container feedback drives ongoing workload distribution to completion. Container feedback includes status reports and data processing statistics. Ongoing workload distribution includes reading portions of data from a target dataset, validating and formatting the portions of data until no more data is available to be read from the target dataset. The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not storage in the form of one or more transitory signals, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Computing environment 100 contains an example of an environment for the execution of at least some of the computer code involved in performing the inventive methods, such as controlled distribution service program 224a. In addition to block 224a, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 224a, as identified above), peripheral device set 114 (including user interface (UI), device set 123, data storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

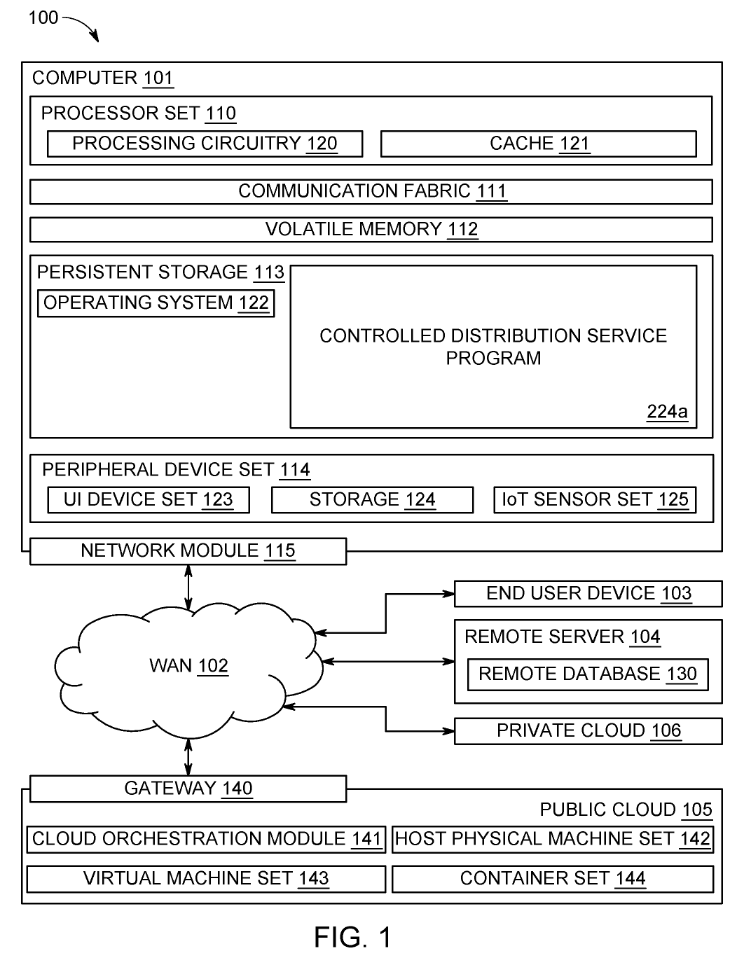

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 224ain persistent storage 113.

COMMUNICATION FABRIC 111 represents the signal conduction paths that allow the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 224atypically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Data storage 124 is external storage, such as an external hard drive, or insertable storage, such as an SD card. Data storage 124 may be persistent and/or volatile. In some embodiments, data storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. Some embodiments of the present invention run a controlled distribution service program, such as controlled distribution service program 224a, in public cloud 105 by, for example, cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud. Some embodiments of the present invention run a controlled distribution service program, such as controlled distribution service program 224a, in private cloud 106 by an orchestration module such as cloud orchestration module 141 (shown in public cloud 105). The controlled distribution service program, according to some embodiments of the present invention may operate in either a public cloud, a private cloud, or in hybrid cloud environment.

The programs described herein are identified based upon the application for which they are implemented in a specific embodiment of the present invention. However, it should be appreciated that any particular program nomenclature herein is used merely for convenience, and thus the present invention should not be limited to use solely in any specific application identified and/or implied by such nomenclature.

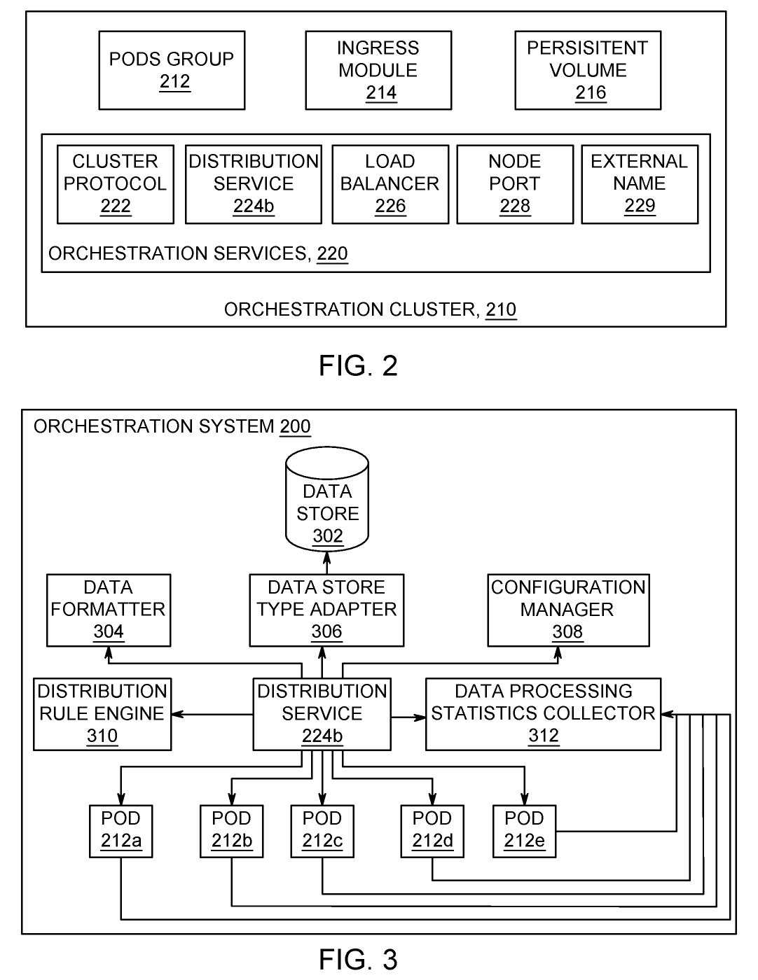

FIG. 2 is a block diagram of a container orchestration cluster embodiment of the present invention. Orchestration cluster 210 may be included in an orchestration system in public cloud 105 or private cloud 106 (FIG. 1). The orchestration cluster includes: orchestration services 220; cluster internet protocol 222; controlled distribution service program 224b; load balancer 226; node port 228; external name 229; pods group 212; ingress module 214; and persistent storage volume 216.

According to some embodiments of the present invention, the controlled distribution service program is a service in a containerized applications cluster that distributes data from a datastore to the various sets of running containers, or pods, connected to the service. The data, as will be discussed in more detail below, may originate from one of various data store types and be translated for processing by a selected set of containers.

FIG. 3 is a component level diagram for orchestration services with a controlled distribution service program in container orchestration system 200 including an orchestration cluster, such as orchestration cluster 210, according to some embodiments of the present invention. Orchestration system 200 includes data store 302; data formatter 304; data store type adapter 306; configuration manager 308; data distribution rule engine 310; controlled distribution service program 224b; data processing statistics collector 312; and pods 212a, 212b, 212b, 212d, 212e in pods group 212 (FIG. 2). Data store 302 can be any kind of data repository that would store a large amount of data. The data store type may be, for example: (a) an SQL Database; (b) a NoSQL Database; (c) a Message Queue; (d) a REST API; (e) a File System; (f) Object Storages of different clouds; (g) a relational database; or (h) a Kafka MQ data store. Note: the terms “KAFKA” and “KAFKA MQ” may be subject to trademark rights in various jurisdictions throughout the world and are used here only in reference to the products or services properly denominated by the mark to the extent that such trademark rights may exist.

Pods group 212 includes the sets of containers that would receive data fetched, for example, from data store 302 by controlled distribution service program 224b. Pods in pods group 212 implement the HTTP API (Record Receiving API) to which the controlled distribution service sends the records. The path of the Record Receiving API is declared in the configuration YAML (YAML ain’t markup language) file of the controlled distribution service program.

Data distribution rule engine 310 contains the distribution rules controlling which data will be fetched from the specified data store and distributed to the various pods. The data distribution rule engine operates according to rules configured in the service description. The rules may provide for control of, for example: (i) the number of records to be sent to a pod in each HTTP request; (ii) the time delay before sending a next batch of records to a pod; and/or (iii) whether or not to wait for confirmation response from a pod before sending next batch of records to the pod.

Data processing statistics collector 312 collects data received statistics and data processed statistics from the pods. The controlled distribution service program queries the data processing statistics collector for the collected statistics. The controlled distribution service program can obtain the statistics on each pod by calling an HTTP API of the data processing statistics collector.

Data store type adapter 306 is an adapter that is connectable to different types of data stores, for example, two or more of, but not limited to: SQL databases, NoSQL databases, file systems, REST APIs, and object storages on different clouds.

Data formatter 304 is a data formatter that converts data from one data format to another data format. The data formatter may be used to convert incoming data received in one data format to another data format before sending is to the pods. The data format conversion rules are described as configurations in the orchestration service description YAML. The data formatter operates to validate the input data format from a data store, such as data store 302, and convert the input data received from the data store to a specified output data format as specified in the service description.

Configuration manager 308 reads and parses the configuration configured in the service description YAML file and makes it available to other components of orchestration system 200.

Some embodiments of the present invention are directed to a data distribution mechanism by which the data is distributed between different pods. Distribution mechanisms may include: (i) range wise distribution, where data is distributed according to the number of records; (ii) chunk wise distribution, where data is distributed according to the size of data; (iii) percentage wise distribution, where data is distributed according to the percentage of data; (iv) round robin distribution, where data is distributed unit by unit to pods in a round robin fashion; (v) data store type wise distribution, where data is distributed from one type of data source to one set of pods, and so on; (vi) data type wise distribution, where one type of data is distributed to one set of pods, and so on; (vii) field value wise distribution, where records with specific field values are distributed to specific sets of pods; (viii) fields condition evaluation wise distribution, where records are distributed by meeting or not meeting specific conditions of specific sets of pods; (ix) processed vs received percentage distribution, where more data is distributed to pods whose processing percentage is higher than other pods; (x) current processing count distribution, where data is distributed according to the current processing count, or workload, of each pod such that pods currently processing less data would receive distributions of additional data than pods currently processing more data; (xi) age of the pod distribution, where more data is distributed to newer or older pods as configured; (xii) random distribution, where data is randomly distributed to the pods.

Some embodiments of the present invention recognize the following facts, potential problems and/or potential areas for improvement with respect to the current state of the art: (i) some container orchestration systems are able to distribute HTTP API requests to multiple pods via a provided service application; (ii) distributing HTTP API requests helps in the creation of highly scalable HTTP API based applications; (iii) some container orchestration systems distribute pods evenly across the nodes of the cluster; and/or (iv) Hadoop is a technology to perform distributed processing of large data sets across clusters of computers. Note: the term “HADOOP” may be subject to trademark rights in various jurisdictions throughout the world and is used here only in reference to the products or services properly denominated by the mark to the extent that such trademark rights may exist.

Some embodiments of the present invention enable development of highly scalable data processing applications that can extract data from a variety of data sources and finish processing the data in a manner directly proportional to the number of deployed pods.

Some embodiments of the present invention are directed to distributing data from one or more datastores of same or different kinds, in parallel to multiple pods of a container orchestration system at a processing rate dependent upon processing completion feedback of each pod. This may be performed reliably on data intensive applications to achieve the fastest possible execution time. In that way, the system is highly scalable for data processing applications.

Some embodiments of the present invention are directed toward distributing data from heterogenous data sources to pods according to pre-configured rules, processing the received data in the pods, updating a processing status of each pod, and redistributing the data among the pods based on available capacity of each pod.

Some embodiments of the present invention are directed toward a process including: reading data from any kind of data store associated with an orchestration service; distributing the data to the pods associated with the orchestration service according to pre-configured distribution rules; formatting and validating the data after reading from the data store and before sending the data to the pods in a specified method and structure, or format; collecting statistics from the pods on the processing status of the data shared to them; and displaying pod-wise data distribution and processing statistics for the orchestration service.

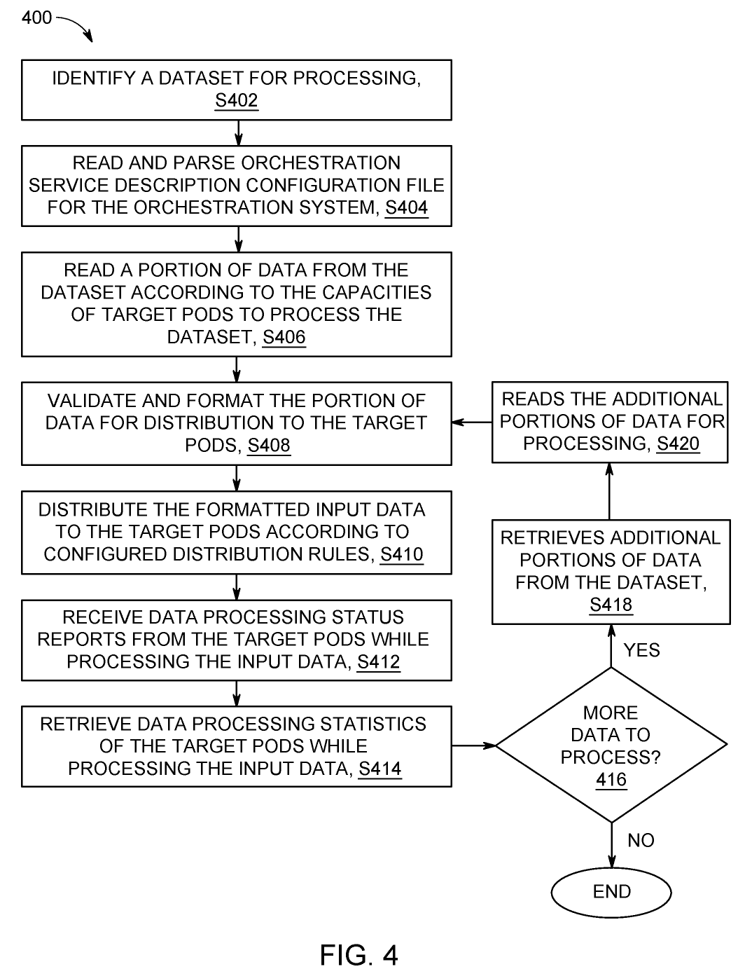

With reference to container orchestration system 200 (FIGS. 2 and 3), controlled distribution service program 224b operates to perform or cause the performance of process 400 illustrated in FIG. 4, as discussed below. Alternatively, controlled distribution service program 224a (FIG. 1) operates to perform or causes the performance of processes according to some embodiments of the present invention, including process 400.

Processing begins at step S402, where orchestration system 200 identifies a dataset of processing. In this example, the dataset is a batch of data containing a significant amount of data to be processed such that a single pod, or container, does not have the capacity to handle the workload of processing the entire dataset. Accordingly, controlled data distribution to multiple pods is managed by controlled distribution service program 224b as described below.

Processing proceeds to step S404, where orchestration system 200 reads and parses an orchestration description configuration file. In this example, controlled distribution service program 224b reads and parses an orchestration service description YAML configuration file for orchestration system 200.

Processing proceeds to step S406, where orchestration system 200 reads a portion of data from the dataset according to the capacities of target pods to process the dataset. In this example, controlled distribution service program 224b reads a portion of the data from data store 302 according to the capacity of individual pods in the set of pods 212a-212e. The set of pods and their capacities are described in the orchestration service description YAML configuration file. Each pod of the set of pods have an HTTP API (record receiving API) implemented to accept records.

Processing proceeds to step S408, where orchestration system 200 validates and formats the portion of data for distribution to the target pods. In this example, data formatter 304 validates and formats input data received from data store 302.

Processing proceeds to step S410, where orchestration system 200 distributes the formatted input data to the target pods according to configured distribution rules. In this example, controlled distribution service program 224b distributes the records read from data store 302 to the individual pods 212a-212eaccording to distribution rules configured by data distribution rule engine 310. The signature of the HTTP APIs of each pod is declared in the orchestration service description YAML configuration file.

Processing proceeds to step S412, where a collector in the orchestration system 200 receives data processing status reports as feedback from the target pods while processing the formatted input data. In this example, each pod processing data received from the controlled distribution service program sends feedback including a status report of the records received and processed to data processing statistics collector 312. The status reports are sent by the pods calling the HTTP API present on each pod.

Processing proceeds to step S414, where a distribution service of orchestration system 200 retrieves data processing statistics of the target pods while the input data is being processed. In this example, controlled distribution service program 224b receives processing statistics by calling the HTTP API of data processing statistics collector 312 during the processing of the formatted input data by the target pods. The processing statistics include records received and processed by the individual pods.

Processing proceeds to decision step S416, where orchestration system 200 determines if more data of the dataset is to be processed. In this example, controlled distribution service program 224b determines whether or not there are more records in the identified dataset of data store 302 available for processing. Processing ends if no more records are available. Processing follows the “Yes” branch to step S418 if there are more records to be processed.

Following the “Yes” branch to step S418, where orchestration system 200 retrieves additional portions of data from the identified dataset. In this example, controlled distribution service program 224b retrieves additional portions of the dataset in data store 302 according to the retrieved statistics regarding the number of records successfully processed by individual pods in the set of pods 212a-212e.

Processing proceeds to step S420, where orchestration system 200 reads the additional portions of data for processing. In this example, controlled distribution service program 224b reads the additional data according to the currently available capacity of the individual pods in the set of pods 212a-212e.

Processing returns to step S408, where a data formatter of orchestration system 200 validates and formats the additional portions of data for processing by the target pods. In this example, data formatter 304 validates and formats the additional data read at step S420. Processing of the entire identified dataset in data store 302 continues from step S408 through step S420 until no additional data remains at decision step S416 and processing follows the “No” branch to end processing.

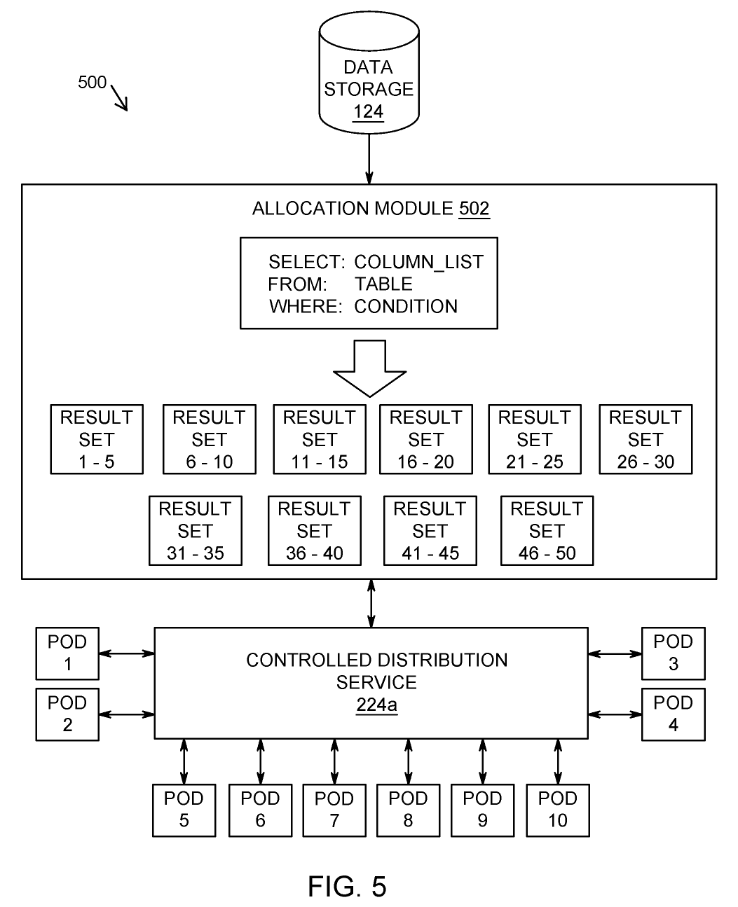

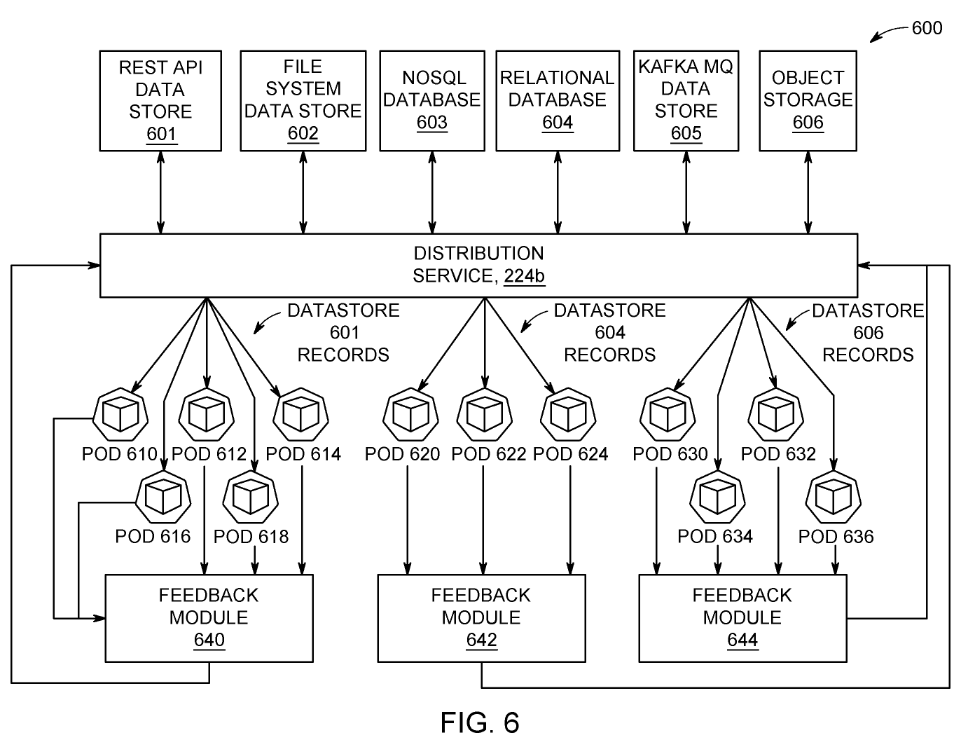

Further embodiments of the present invention are discussed in the paragraphs that follow and later with reference to FIGS. 5 and 6.

Some embodiments of the present invention rely upon the incorporation of certain processes including: (i) an incoming API where the data distribution service sends the record; and (ii) calling an outgoing API to the data processing statistics collector where the application sends the processing completion status of each record.

Some embodiments of the present invention are directed toward a process including: (i) an orchestration service to read records from any kind of datastoreand share it to the pods associated with this orchestration service as per the distribution rule configured; collect live processing completion status for each record from each pod; distribute a newer count of records to pods for processing when the pods have completed processing a specified number of older records; and continue the above process until all the data marked for processing in the data store has been processed.

Some embodiments of the present invention are directed to validating records after reading from a data store and before sending to a pod as specified in the service description.

Some embodiments of the present invention are directed to collecting live processing completion statuses from each pod for each record processed.

FIG. 5 shows data distribution system 500 according to some embodiments of the present invention. Data distribution system 500 operates to distribute data to pods from a single data store, such as data store 302 (FIG. 3). In this example, controlled distribution service program 224a (FIG. 1) is used along with corresponding data storage 124, allocation module 502, and a container set including pods 1-10.

As illustrated in data distribution system 500, a batch of data is retrieved from data storage 124 and allocated to various available pods according to the capacity of each pod as specified in the orchestration service description YAML configuration file. In this example, allocation module 502 establishes initial allocation strategy for processing by controlled distribution service program 224a. The allocation strategy, as shown, involves establishing ten result sets of records 1-50, the result sets containing selected portions of the identified dataset in data storage 124, as shown, for example, result set 1-5 contains records 1, 2, 3, 4, and 5 and result set 16-20 contains records 16, 17, 18, 19, and 20. Distribution of the ten result sets by controlled distribution service 224a may be as follows: Pod 1 is distributed records 1-5, Pod 2 is distributed records 6-10, and so forth until Pad 10 is distributed records 46-50. If there were additional data to be distributed, the data distribution service would receive status updates for each pod while processing portions of the batch of data so that additional portions may be distributed to pods according to availability to complete processing.

FIG. 6 shows data distribution system 600 according to some embodiments of the present invention. Data distribution system 600 operates to distribute data workloads to pods from multiple data stores including: REST API data store 601, File system data store 602, NoSQL Database 603, relational database 604, Kafka data store 605, and object storage 606. In this example, controlled distribution service program 224b (FIG. 2) is used along with the corresponding set of data stores 601, 602, 603, 604, 605, and 606 to distribute dataset processing tasks to designated groups of pods in a container set of pods 610, 612, 614, 616, 618, 620, 622, 624, 630, 632, 634, and 636. As shown in FIG. 6, records in a dataset on data store 601 are distributed among pods 610, 612, 614, 616, and 618. Records in a dataset on data store 604 are distributed among pods 620, 622, and 624. Records in a dataset on data store 606 are distributed among pods 630, 632, 634, and 636. The number of individual pods used for processing various datasets depends upon several factors including, for example: (a) the number of records to be processed; (b) level of urgency of the data processing task; (c) pod availability (current and/or historic); and (d) size of the individual pods being selected.

As illustrated, for each set of pods processing a target dataset from a given data store, there is a separate feedback module 640, 642, and 644. The feedback modules may also be referred to data processing statistics collectors as the feedback modules operate to collect pod workload statistics. The feedback modules return statistics to the controlled distribution service program until there are no additional records to be processed from the corresponding data store. In some embodiments of the present invention, controlled distribution service program 224b periodically requests a statistical report from feedback modules. The statistical report, regardless of how it is received by the controlled distribution service program, provides feedback to facilitate determination of read operations taken at the various data stores.

Some embodiments of the present invention are directed to controlled distribution of data in Kubernetes. In one example, there are one trillion records to be processed by an application deployed on only ten pods on five nodes of a Kubernetes cluster. Each record takes five seconds for processing. In a conventional system, if all the records are sent to the ten pods for processing at once, the pods would crash. By controlling data distribution to ensure that the data distribution service only shares a controlled amount of records to any given pod, such as an amount under the processing capacity of the pod as defined in the service configuration, the records will get processed by any size of Kubernetes infrastructure and any number of pods without crashing the pods and the application.

Some embodiments of the present invention are directed to a computer-implemented method for a data distribution service in a container orchestration system, the method comprising: identifying a dataset of processing; reading and parsing an orchestration service description configuration file for the orchestration system; reading a portion of data from the identified dataset according to pre-defined capacities of individual pods in a set of target pods; validating and formatting the portion of data for distribution of formatted input data to the set of target pods; distributing the formatted input data to the target pods according to configured distribution rules; retrieving data processing statistics of the target pods while processing the formatted input data; responsive to additional portions of data being available for processing, retrieving an additional portion of data from the dataset; and reading the additional portion of data for continued processing of the dataset until completion. Some embodiments of the present invention may further include: validating and formatting the additional portion of data for distribution to selected target pods based on current capacities of the set of target pods; and distributing the formatted input data to the selected target pods.

Some helpful definitions follow:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above – similar cautions apply to the term “embodiment.”

and/or: inclusive or; for example, A, B “and/or” C means that at least one of A or B or C is true and applicable.

User / subscriber: includes, but is not necessarily limited to, the following: (i) a single individual human; (ii) an artificial intelligence entity with sufficient intelligence to act as a user or subscriber; and/or (iii) a group of related users or subscribers.

Module / Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method for controlled parallel distribution of a data workload via container orchestration, the method comprising:
reading input data from a dataset in storage, the input data being a portion of the dataset, the portion determined according to pre-defined capacities of a set of containers including individual containers, the set of containers being assigned to process the dataset;
distributing, in parallel, batches of the input data to the set of containers, the batches assigned to the individual containers according to configured distribution rules;
retrieving data processing status reports from the individual containers while processing their respectively assigned batches; and
distributing additional input data to the individual containers based on the retrieved data processing status reports.

2. The method of claim 1, further comprising:
formatting the input data for distribution to the set of containers;
wherein:
the input data is specifically formatted for processing by the set of containers.

3. The method of claim 1, further comprising:
reading an orchestration service description configuration file for container orchestration, the orchestration service description configuration file including the configured distribution rules and the pre-defined capacities of the individual containers.

4. The method of claim 1, wherein the storage is of a type selected from the group:
a) REST (representative state transfer) API (application programming interface) storage;
b) SQL (structured query language) database;
c) NoSQL (not only SQL) database; and
d) file system storage.

5. The method of claim 1, further comprising:
analyzing the processing status reports to determine current capacities of the individual containers;
retrieving the additional input data from the dataset in the storage based on the current capacities;
formatting the additional input data for distribution; and
distributing the formatted additional input data to the individual containers according to the current capacities.

6. The method of claim 1, wherein:
distributing the additional input data is performed responsive to the additional input data being available in the dataset.

7. A computer program product comprising a computer readable storage medium having a set of instructions stored therein which, when executed by a processor, causes the processor to control parallel distribution of a data workload via container orchestration by:
reading input data from a dataset in storage, the input data being a portion of the dataset, the portion determined according to pre-defined capacities of a set of containers including individual containers, the set of containers being assigned to process the dataset;
distributing, in parallel, batches of the input data to the set of containers, the batches assigned to the individual containers according to configured distribution rules;
retrieving data processing status reports from the individual containers while processing their respective assigned batches; and
distributing additional input data to the individual containers based on the retrieved processing status reports.

8. The computer program product of claim 7, further causing the processor to perform a process by:
formatting the input data for distribution to the set of containers;
wherein:
the input data is specifically formatted for processing by the set of containers.

9. The computer program product of claim 7, further causing the processor to perform a process by:
reading an orchestration service description configuration file for container orchestration, the orchestration service description configuration file including the configured distribution rules and the pre-defined capacities of the individual containers.

10. The computer program product of claim 7, wherein the storage is of a type selected from the group:
a) REST (representative state transfer) API (application programming interface) storage;
b) SQL (structured query language) database;
c) NoSQL (not only SQL) database; and
d) file system storage.

11. The computer program product of claim 7, further causing the processor to perform a process by:
analyzing the processing status reports to determine current capacities of the individual containers;
retrieving the additional input data from the dataset in the storage based on the current capacities;
formatting the additional input data for distribution; and
distributing the formatted additional input data to the individual containers according to the current capacities.

12. The computer program product of claim 7, wherein:
distributing the additional input data is performed responsive to the additional input data being available in the dataset.

13. A computer system for controlled parallel distribution of a data workload via container orchestration, the computer system comprising:
a processor set; and
a computer readable storage medium;
wherein:
the processor set is structured, located, connected, and/or programmed to run program instructions stored on the computer readable storage medium; and
the program instructions which, when executed by the processor set, cause the processor set to perform a process by:
reading input data from a dataset in storage, the input data being a portion of the dataset, the portion determined according to pre-defined capacities of a set of containers including individual containers, the set of containers being assigned to process the dataset;
distributing, in parallel, batches of the input data to the set of containers, the batches assigned to the individual containers according to configured distribution rules;
retrieving data processing status reports from the individual containers while processing their respective assigned batches; and
distributing additional input data to the individual containers based on the retrieved processing status reports.

14. The computer system of claim 13, further causing the processor to perform a process by:
formatting the input data for distribution to the set of containers;
wherein:
the input data is specifically formatted for processing by the set of containers.

15. The computer system of claim 13, further causing the processor to perform a process by:
reading an orchestration service description configuration file for container orchestration, the orchestration service description configuration file including the configured distribution rules and the pre-defined capacities of the individual containers.

16. The computer system of claim 13, wherein the storage is of a type selected from the group:
a) REST (representative state transfer) API (application programming interface) storage;
b) SQL (structured query language) database;
c) NoSQL (not only SQL) database; and
d) file system storage.

17. The computer system of claim 13, further causing the processor to perform a process by:
analyzing the processing status reports to determine current capacities of the individual containers;
retrieving the additional input data from the dataset in the storage based on the current capacities;
formatting the additional input data for distribution; and
distributing the formatted additional input data to the individual containers according to the current capacities.

18. The computer system of claim 13, wherein:
distributing the additional input data is performed responsive to the additional input data being available in the dataset.
